(19) United States
(12) Patent Application Publication
(10) Pub. No.: US 2026/0254309 A1
(43) Pub. Date: Aug. 27, 2026

(54) DRIVE WITH COMBINED CHOKE

(71) Applicant: Innomotics GmbH, Nüremberg (DE)

(72) Inventors: Christian Deeg, Altdorf (DE); Philipp Jordan, Hirschaid (DE); Tobias Katzenberger, Bad Königshofen (DE); Thomas Koch, Nümberg (DE); Johannes Lehner, Auerbach in der Oberpfalz (DE); Marco Steinmüller, Mellrichstadt (DE); Hans Tischmacher, Lauf an der Pegnitz (DE); Matthias Warmuth, Windshausen (DE)

(73) Assignee: Innomotics GmbH, Nüremberg (DE)

(21) Appl. No.: 19/545,738

(22) Filed: Feb. 20, 2026

(30) Foreign Application Priority Data
Feb. 21, 2025 (EP) 25159314.1

(51) Int. Cl. H02K 5/15

(52) U.S. Cl. CPC H02K 5/15

(57) ABSTRACT

A drive includes a dynamo-electric rotary machine arranged in the housing and including a stator, a winding system arranged in the stator, and a rotor separated from the stator by an air gap, with the stator and the rotor being located in a motor interior. A B-side pot-shaped bearing shield includes a bearing supporting the rotor for rotation about an axis. A converter is situated in a converter installation space which is radially surrounded at least in one section by the B-side bearing shield.. The converter is arranged, as viewed axially, between the dynamo-electric rotary machine and the bearing of the B-side bearing shield and has at least one component, such as power semiconductor, capacitor, control and regulating unit, and communications unit, which is thermally conductively connected to the B-side bearing shield. A choke body separates the motor interior and the converter installation space and includes chokes.

### CROSS-REFERENCES TO RELATED APPLICATIONS

This application claims the priority of European Patent Application, Serial No. 25159314.1, filed Feb. 21, 2025, pursuant to 35 U.S.C. 119(a)-(d), the disclosure(s) of which is/are incorporated herein by reference in its entirety as if fully set forth herein.

The content of European Patent Application, Serial No. 25159314.1 is incorporated herein by reference in its entirety as if fully set forth herein.

### BACKGROUND OF THE INVENTION

The invention relates to a drive with combined choke.

The following discussion of related art is provided to assist the reader in understanding the advantages of the invention, and is not to be construed as an admission that this related art is prior art to this invention.

Variable-speed dynamo-electric machines, such as electric motors, e.g. synchronous, asynchronous and reluctance motors, require frequency converters to set the desired speed.

The increase in decentralized, fluctuating energy generators (photovoltaics, wind power) and the simultaneous increase in the number of non-linear loads (e.g. converters, charging stations, LED lighting, power supplies, etc.) result in a sometimes drastically impaired supply network quality in the form of voltage fluctuations, harmonics, pulse-frequency interference emissions and radio interference. At the same time, the normative requirements for electrical power quality are becoming increasingly stringent, especially for the frequency range from 2 kHz to 150 kHz, which in the past was not regulated by normative regulations.

While some of the standards define the permissible compatibility levels, another part of these standards describes the product standard that is relevant to the CE marking.

In particular, strong networks with an RSC>>50 (Relative Short-Circuit Power) show a high harmonic current content in the range of 0 . . . 2.5 kHz despite a line choke, with the result that filtering beyond the line choke is recommended. In the case of weak networks, i.e. with a small relative short-circuit power (RSC<15), it should be noted that the circuit feedback, i.e. the voltage harmonics in the line voltage, increases.

Chokes are usually used to limit the peak value in the line current of the converter and to reduce harmonics in the line current. These are provided either in the DC link or at the converter input, i.e. on the line side. Depending on the converter design, a combination of line choke and DC link choke may be envisioned. However, line chokes and DC link chokes take up installation space.

The available installation space within a motor-integrated converter arrangement is limited. Previously known choke components can hardly be accommodated in the active range of the motor converter arrangement. It was therefore proposed to position the choke outside the motor housing. However, installation is time-consuming and requires additional cable routing. Moreover, the clearance gauge of the motor is increased as a result.

Frequency converters are usually provided in separate control cabinets or are also mounted on the outside of the housing of the dynamo-electric machine. There are different approaches for mounting the converter on the housing; for example, as an attachment with its own ventilation or else with integrated ventilation by the motor fan.

When decentralized converters are involved, the connection between the converter and the motor is made via a supply cable to the terminal board. When the converter is placed on the motor, the connector cables are routed through openings in the housing to the converter. This manual effort to guide stator cables and additional cables from the winding through the housing opening causes disproportionately high installation costs, especially for relatively small sizes. Moreover, the drive system loses compactness due to the individual components (motor and converter) being connected together, as a result of which the interchangeability of the drive systems is lost.

It would therefore be desirable and advantageous to obviate prior art shortcomings and to provide a compact drive of simple construction for a wide range of applications.

### SUMMARY OF THE INVENTION

According to one aspect of the present invention, a drive includes a housing, a dynamo-electric rotary machine arranged in the housing, with the dynamo-electric rotary machine including a stator, a winding system arranged in the stator, and a rotor which is separated from the stator by an air gap, with the stator and the rotor being located in a motor interior, a B-side pot-shaped bearing shield including a bearing supporting the rotor for rotation about an axis, a converter including at least one component selected from the group consisting of power semiconductor, capacitor, control and regulating unit, and communications unit, the converter being situated in a converter installation space which is radially surrounded at least in one section by the B-side bearing shield, wherein the at least one component of the converter is thermally conductively connected to the B-side bearing shield, wherein the converter is arranged, as viewed axially, between the dynamo-electric rotary machine and the bearing of the B-side bearing shield, and a choke body separating the motor interior and the converter installation space and including chokes.

The dynamo-electric rotary machine may involve a synchronous machine, asynchronous machine or reluctance machine, which is at least predominantly arranged in the housing. The stator can be shrink-fitted or press-fitted into the housing, with the winding system being essentially received in axially extending grooves of the stator and generating a torque on a shaft that is connected fixedly to the rotor for conjoint rotation when energized due to electromagnetic interactions. Fitting the stator into the housing creates a good heat transfer from the laminated core of the stator to the housing and optional housing fins. The rotor is mounted rotatably about its axis via at least one bearing of the B-side pot-like bearing shield.

In a dynamo-electric machine, such as a motor, there is an A-side (output side; Drive End; DE side), one shaft end of which points towards shaft attachment elements, such as output elements and/or a work machine, and is mechanically coupled to this work machine. The B-side of the motor lies at the other shaft end (Non-Drive End; NDE side).

The converter of the drive may be designed as a converter with DC link, as a direct converter, etc., and has at least some of the following components, such as power semiconductors, capacitors, control and regulating units and communications units. The converter occupies a converter installation space and is radially and circumferentially surrounded by the B-side bearing shield at least in sections. At least some components of the converter are hereby thermally conductively connected to the bearing shield, e.g. by arranging heat-intensive components of the converter on an inner side wall of the pot-like bearing shield. The converter is arranged, as viewed axially, between the dynamo-electric rotary machine and the bearing of the B-side pot-like bearing shield. The choke body, which includes chokes is placed between the motor interior and the converter installation space. This motor-integrated combined choke minimizes circuit feedback of the drive comprising a motor-converter system.

The power semiconductors of the converter, such as IGBTs, which are particularly heat-intensive, i.e. power-loss-generating components of the converter, are in thermally directly conductive contact with the bearing shield, advantageously with the side wall of the pot-like B-side bearing shield. This provides direct thermal coupling to the side walls of the pot-like bearing shield, such that the heat dissipation from the converter is facilitated, advantageously via the side walls. This results in a compact design of the drive.

The chokes may involve coils or inductors to limit the peak value in the line current of the converter and to reduce the harmonics in the line current. They are usually connected in series with other components of the converter or the loads. The chokes each form a closed magnetic circuit and therefore have only small stray magnetic fields. This low scatter contributes, i.a., to improved electromagnetic compatibility.

In order to reduce eddy currents in the coil core, the chokes can have a ferromagnetic core made of insulated electrical sheets that are oriented longitudinally with respect to the magnetic field. This both reduces the losses arising in the coil core and increases the inductance. Both facilitate a compact choke design.

The chokes do not affect DC and low-frequency currents, or affect them only a little, whereas high-frequency alternating currents are effectively reduced by their high inductive resistance, and thus lead to compliance with necessary limit values in the line current. Since the choke limits high-frequency current components, steep current rise edges are flattened and rectified alternating currents are smoothed, which also contributes to the reduction of the harmonics in the line current.

The chokes operate in series with a line supply voltage in the rectifier to reduce the harmonic load of the line supply.

The choke body thus has a ferromagnetic core made of electrical sheets which are axially layered in the housing in the fixed state. The choke body is thus stacked from individual laminations and held together by package punching or by baked lacquer or by package punching.

According to another advantageous feature of the invention, the individual sheets can also be constructed from choke body elements which are connected circumferentially only by a sheet metal web in each case. The choke body can thus have a split configuration. The coils of the choke can either be machined on a winding body and then plugged onto the teeth of the choke body or the choke body elements, or can be wound directly onto the previously insulated choke body or the choke body elements. Optionally, the triangular area between two circumferentially adjacent coils can thus also be wound. The axial extent of the coil has to be considered hereby. Due to the specially formed sheet metal web, the coils can be folded together on the choke body elements almost without gaps.

The choke body carries the DC link chokes of the converter, advantageously two DC link chokes, as well as the line chokes between the rectifier of the converter and the line supply, advantageously three line chokes. The choke body can have an outer part with teeth and a separate inner part with a shaft feedthrough. The required gap can be established between the outer and inner parts via spacer elements or a contiguous spacer tube. The folded choke body elements can be inserted axially into the housing as an assembled choke body and fixed there in the specified section. For this purpose, spreader wedges can be introduced on one or both sides.

Contacting of the choke in the assembly sequence depends on the contacting concept of the drive. Provision can be made for both a line-side connection and a connection to the DC link of the converter. The winding system shall be fed from the inverter side of the converter.

Possible variants of the combined choke include different geometric dimensions of DC link and line chokes (asymmetrical geometry) and the division of the respective coils into a plurality of individual coils in series connection. This can be thermally and/or geometrically advantageous (approximation of the coil cross section to a rectangle), but the achievable inductance may decrease hereby. The geometry and arrangement of the choke body or the combined choke can be adapted to the housing of the motor, resulting in an optimum use of space, and thus a greatest possible choke inductance and therefore also a greatest possible effect in terms of minimizing the circuit feedback can be achieved. There is therefore no need for external chokes so that the clearance gauge of the motor is preserved (advantage when retrofitting).

As can be shown by calculations for a voltage DC link converter with diode infeed, a greatest reduction in line harmonics is achieved by a combination of DC link chokes with line chokes.

The interior of the drive is comprised of the motor interior and the converter installation space, which are axially limited by the A-side and B-side bearing and are separated by the choke body arranged between the motor interior and the converter installation space.

When viewed in the axial direction, the converter or its components is/are integrated directly behind the stator with winding, i.e. the winding head, into the housing and/or into the bearing shield. The chokes, i.e. the line chokes and/or DC link chokes of the choke body, are hereby arranged between the converter installation space and the motor active part. The components of the converter can also be distributed across the adjacent sections of the housing and bearing shield. The electronics of the converter and the winding head of the stator can be spaced apart in the axial direction by merely approximately 10 to max. 100 mm.

The choke body can be introduced-as viewed axially-between the winding head of the stator and the converter installation space. A contour of the outer circumference of the choke body can hereby be adapted to an inner contour of the housing in order to obtain a best possible heat transfer from the choke body to the housing.

According to another advantageous feature of the invention, the choke body can be of annular design in its cross-sectional form-i.e. as viewed perpendicularly with respect to the axis.

A good heat dissipation can be achieved on the converter side by arranging the power semiconductors of the converter, such as the IGBTs, in axially running, tangentially oriented pockets on the inner side wall of the pot-like bearing shield, advantageously being thermally coupled, e.g. by clamping or spring elements.

In addition or as an alternative, the power semiconductors of the converter can also provide an additionally improved thermally conductive contact, between the components of the converter and the bearing shield, with the inner side wall of the bearing shield through heat-conductive potting.

The bearing shield and/or the housing can be manufactured by a die-casting process. The bearing shield and/or housing can be made of thermally conductive material, such as aluminum or an aluminum alloy. By way of the die-casting process, the bearing shield and a wide variety of geometries in the bearing shield, such as the pockets, can be introduced, such that, i.a., the IGBTs can be fastened without additional screw connections. This can be realized by clipping, tensioning or inserting the IGBTs into a conical rail of the pocket or the like. For fixing the IGBTs and for improved dissipation of the loss energy, the IGBTs may, optionally, also be potted/bonded with special heat-conductive resin.

Optionally, provision may be made for an additional fan unit, which is designed as internal and/or external ventilation and which creates an air flow, at least in sections, around the bearing shield and/or the housing, and can additionally improve the required cooling effect. This fan unit can be attached to the NDE side in an axial extension.

According to another advantageous feature of the invention, axially and/or radially aligned cooling fins on the bearing shield and/or housing of the dynamo-electric rotary machine can be provided to increase the cooling efficiency of the drive. These cooling fins on the outer diameter ensure a satisfactory cooling action of electronic components. The cooling fins are advantageously arranged in the cooling air flow of the motor and thus ensure a highly efficient dissipation of the loss energy.

The axially running cooling fins of the bearing shield and housing may either be oriented axially flush or offset by a specified angular offset in order to improve cooling performance. Circumferential offset of the cooling fins of the housing and the bearing shield by half a spacing between two housing fins can increase turbulence, such that a turbulent flow, i.a., achieves an improved cooling effect.

The entire power electronics in the converter installation space can thus be attached directly to the bearing shield, the side walls and/or the pot bottom. By integrating the power electronics into the bearing shield and thus into the converter installation space, many functions (seating of the bearing, fixing of the power and control electronics, etc.) can be combined according to the invention. The additional arrangement of the choke body makes effective use of the internal space of the drive and thus creates a compact drive, which also leads to a minimization of the circuit feedback. In addition, fastening threads can also be made in the bearing shield to attach further modular attachments, such as sensor devices and/or communications devices.

The bearing on the NDE side, advantageously a ball bearing, can be axially mounted from the outside or dismantled when the bearing is changed. This also allows interchangeability in the event of a fault without having to disconnect the motor from the work machine on the A side and remove the converter.

The converter or converter installation space and the choke body have a central passage for the shaft. The power electronics of the converter require merely a passage for the shaft of the motor on the inside (diameter motor shaft+1 mm =shaft passage in the converter installation space) and not, as is usual, a large passage for the bearing. This creates additional structural volume for the components of the converter, e.g. the power electronics, and makes the drive with its motor-converter system even more compact axially by allowing the choke body according to the invention to also be accommodated in the drive.

The bearing shield thus has a functional integration, i.a., of power electronics in the motor interior. The components of the converter do not require a separate housing because all fastening points are integrated into the B-side bearing shield. This makes optimum use of the drive space and creates a drive with a compact motor converter system with choke body. There is no obstruction to a module concept on the NDE side of the motor, i.e. all conceivable attachments to the NDE shaft end, such as brakes, external fans, or an encoder, are still possible.

The B-side bearing shield can be fitted with the entire components of the converter in advance and, if necessary, potted. This creates a ready-to-install converter system. This converter system contacts the line voltage via its input converter and a terminal board of a terminal box, while the output side of the converter system can contact the winding system of the motor. These contacts are advantageously realized when the bearing shield is installed on the housing.

The B-side bearing shield has a substantially pot-shaped design. The pot bottom can have a cut-out, through which the shaft protrudes, which forms, i.a., the drive shaft of the cooling unit, advantageously of a fan. The abovementioned attachments can also be attached to this shaft fixedly for conjoint rotation. The side wall can have axially extending fins on its circumferential outer side. The inner side of the pot-shaped bearing shield is advantageously of polygonal design in order to be able to easily arrange the power semiconductors as directly as possible on the inner side of the bearing shield and thus on the heat sink. This ensures a thermally satisfactory attachment of these components to the side wall of the bearing shield.

Depending on the embodiment, the converter system thus can have power semiconductors, chokes, capacitors, control and regulating units and communications units that are accommodated in the specified structural volume. Large heat sources, such as the power semiconductors of the input and output converters on the inner side wall of the B-side bearing shield of pot-like design, can advantageously be thermally coupled with low heat transfer resistance.

The components of the converter system, like the power semiconductors and also the control and regulating electronics, can be cooled via thermal coupling to the circumferential side walls and/or the end side of the bearing shield, i.e. the pot bottom. Both the stator and the rotor generate heat which heats up, i.a., the interior of the dynamo-electric rotary machine. In particular, the winding head of the winding system of the stator can briefly reach temperatures above 180° C. This heat input from the dynamo-electric machine is likewise dissipated by the air flowing around the housing and the bearing shields. Furthermore, the stator is advantageously shrink-fitted into a casing of the housing in order to obtain effective heat transfer from the laminated core of the stator to the housing and the housing fins.

In operation of the dynamo-electric rotary machine, a cooling unit designed, e.g., as an integral fan generates a cooling air flow which can be guided radially along the pot bottom of the bearing shield and then the outer side wall of the bearing shield. A fan hood that extends axially in the direction of the AS bearing may also guide the cooling air flow along the cooling fins of the bearing shield and housing of the dynamo-electric rotary machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a basic longitudinal section of a drive according to the invention with a choke body,

FIG. 1A shows an enlarged detailed view of the area encircled in FIG. 1 and marked A;

FIG. 2 shows a basic cross section of a choke body,

FIG. 3 shows a section of a choke body with choke body elements,

FIG. 4 shows a sheet metal web between two choke body elements,

FIG. 5 shows two assembled choke body elements, and

FIG. 6 shows a section of a circuit diagram of a converter.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

To ensure clarity, it is necessary to establish a definition of several important terms and expressions that will be used throughout this disclosure. The terms “axial”, “radial”, “tangential” refer to an axis depicted in the drawings or in the example described in each case. In other words, the directions “axial”, “radial”, “tangential” refer to axis 12 of rotor 6 and thus to a corresponding axis of symmetry of stator 4. “Axial” describes hereby a direction parallel to the axis 12, “radial” describes a direction orthogonal with respect to the axis 12, towards or away from it, and “tangential” is a direction that is directed at a constant radial spacing from the axis 12 and, at a constant axial position, circularly around the axis 12. The term “in a circumferential direction” is equivalent to “tangential”.

In relation to a surface, e.g. a cross-sectional surface, the terms “axial”, “radial”, “tangential” describe the orientation of the normal vector of the surface, i.e. that vector which lies perpendicularly on the relevant surface.

The term “coaxial components”, e.g. coaxial components, such as rotor 6 and stator 4, are understood in the following description to relate to components which have identical normal vectors, for which the planes defined by the coaxial components are therefore parallel to each other. Furthermore, the term “coaxial components” shall include that the center points of coaxial components lie on a same axis of rotation or symmetry. However, these center points can lie on this axis at different axial positions, and the abovementioned planes can therefore be at a spacing >0 from each other. The term “coaxial components” does not necessarily require coaxial components to have a same radius.

The term “complementary” in connection with two components, which are “complementary” with respect to each other, is to be understood that their outer shapes are designed in such a way that the one component can be arranged completely in the component which is complementary with respect to it, such that the inner surface of the one component and the outer surface of the other component make contact with each other ideally, without gaps or completely. Consequently, in the case of two objects which are complementary with respect to each other, the outer shape of one object is determined by the outer shape of the other object. The term “complementary” could be replaced by the term “inverse”.

For ease of illustration, in the cases where components are present multiple times, all the components shown are often not provided with reference signs in the drawings.

The described embodiments in the following description can be combined as desired. Likewise, individual features of the respective embodiments can be combined without departing from the scope of the invention.

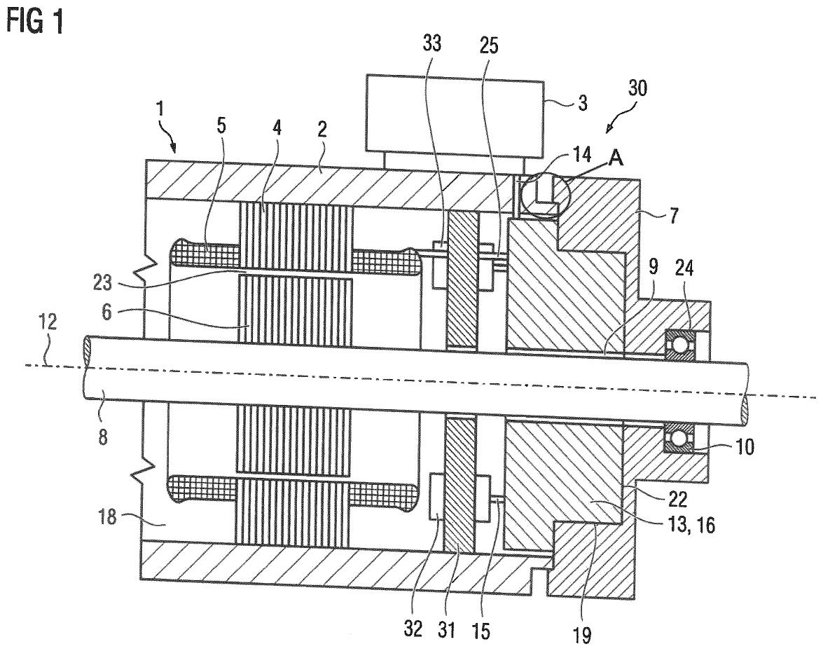

Turning now to the drawing, and in particular to FIG. 1, there is shown a drive generally designated by reference numeral 30 and including a dynamo-electric rotary machine 1 and a converter 16. The dynamo-electric rotary machine 1 includes a stator 4 which forms a laminated core from axially layered laminations. A winding system 5 facing an air gap 23 is arranged in substantially axially running grooves of the laminated core of the stator 4. The winding system 5 forms a winding head on each of the end sides of the laminated core of the stator 4. A rotor 6 includes a laminated core which is connected fixedly to a shaft 8 for conjoint rotation and which is in electromagnetic interaction with the energized winding system 5 of the stator 4, thereby causing a rotation of the shaft 8 about an axis 12. The shaft 8 is held rotatably in two bearings, one AS (Drive Side) bearing (not shown in detail) and one BS (Non-Drive Side) bearing 10.

The rotor 6 can be designed as an asynchronous rotor, a permanently excited rotor or a reluctance rotor.

The dynamo-electric rotary machine 1 is surrounded by a housing 2 which is delimited on the end faces by bearing shields 7. The BS bearing 10 is supported by its B-side bearing shield 7 of pot-like design. The housing 2 and the B-side bearing shield 7 of pot-like design have substantially axially running cooling fins 11 on their outer circumference, as shown by way of the detailed enlarged view of FIG. 1A..

The B-side bearing shield 7 is connected to the housing 2 via its side walls 19. The structural interface of the housing 2 and the B-side bearing shield 7 does not have to coincide with the spatial separation of the motor interior 18 and the converter installation space 13 as shown in FIG. 1. Advantageously, however, a mechanical and/or thermal connection of a choke body 31 to the housing 2 and/or the bearing shield 7 can take place at this interface. The bearing shield 7 is hereby screwed to the housing 2, with radially outer regions of the choke body 31 being located on or between the bearing shield 7 and the housing 2 at least in sections.

The converter 16 feeds the dynamo-electric rotary machine 1, with the following components, such as power semiconductors, capacitors, control and regulating units and communications units, and is accommodated in the converter installation space 13. The choke body 31 is arranged between the converter installation space 13 and the motor interior 18. Contacting 14, 15 of the respective relevant components of the converter 16 to a terminal box 3 and/or to the winding system 5 and/or to chokes 33, 32 of the choke body 31 is advantageously established via plug contacts.

The converter 16 is stationary, and the converter installation space 13 and the choke body 31 have a shaft passage 9 which has, depending on a height of the saturation-related choke stray fields, a spacing of between 1 mm and 10 mm of its radially internal components from the shaft 8. The BS bearing 10 is arranged on a pot bottom 22 of the bearing shield 7. This makes it easier to change bearings, while maximizing the converter installation space 13.

Within the converter installation space 13, in particular those components of the converter 16 that require more intensive cooling, such as the power electronics, are thermally coupled to the inner side walls of the bearing shield 7, and/or also to the axially adjacent housing section.

In this exemplary embodiment, the bearing 10 has a bearing seat 24 of tubular design to facilitate disassembly of the bearing 10.

The converter installation space 13 is restricted to the interior of the bearing shield 7 and/or protrudes axially at least in sections beyond the side walls 19. The converter 16 occupying the converter installation space 13 thus forms a pre-mountable structural unit which only has to be electrically contacted with the winding system 5 and/or the chokes of the choke body 31 and/or with the terminal box 3.

The pot bottom 22 of the B-side bearing shield 7 has a tube-shaped bearing seat 24 of the bearing 10 according to FIG. 1. The pot bottom 22 of the B-side bearing shield 7 can also be completely smooth, i.e. can be designed in a plane perpendicular with respect to the axis 12.

The shaft 8 protrudes from the drive 30 on both the A and B sides. A work machine, such as a compressor or a pump, is connected on the A-side. A fan and/or module-type attachments such as a brake unit, an external fan module or an encoder, in particular a rotary pulse encoder, can be fitted on the B side.

The tube-shaped bearing seat and the bearing shield 7 are advantageously formed in one piece. The cooling fins 11 on the outer side wall of the bearing shield 7 are arranged advantageously in parallel in sections.

The converter installation space 13 protrudes axially beyond the bearing shield 7 with a section which protrudes axially beyond the side walls 19 and is situated in the housing 2 of the dynamo-electric rotary machine 1 in the assembled state. The choke body 31 is then to be fitted there, for example, in an inner circumferentially running recess of the housing 2.

The bearing shield 7 may, optionally, be attached together with the choke body 31 to the housing 2 via fastening elements.

The converter installation space 13, like the choke body 31, has a smallest possible shaft passage 9.

Axially running tangentially oriented pockets are provided in the inner side walls of the bearing shield 7, in which pockets the power semiconductors of the converter are arranged in particular, and which are thermally coupled to the side walls 19 of the bearing shield 7 there.

Flat surfaces are provided circumferentially on the inner side wall 20 of the bearing shield 7 for positioning the power semiconductors. The number of these flat surfaces depends on the number of heat-intensive heat sources.

An internal or external fan can be provided axially on the B side, which fan generates a cooling air flow which is guided by an optional fan hood. The air flow is fed to the fan via a suction opening in the hood.

Heat to be dissipated from the dynamo-electric rotary machine 1 is composed, i.a., of the heat loss of the stator 4 and the rotor 6.

The bearing shield 7 is made of thermally highly conductive material, such that the heat loss of the components of the converter 16, in particular of the power semiconductors, can be dissipated on the flat surfaces from the converter installation space 13 to the outer side wall of the bearing shield 7 and/or to a cooling air flow. Additional cooling fins 11 on the housing 2 and/or on the outer side wall of the bearing shield 7 increase the heat dissipation effect, in particular when a fan hood conducts the cooling air flow.

In order to enlarge the surface area of the bearing shield 7, the pot bottom 22 additionally has, on its outside, fins 11 which extend radially or are arranged in parallel. Advantageously, the fins 11 of the bearing shield 7 and the fins 11 of the housing 2 of the dynamo-electric rotary machine 1 are in axial alignment, and thus oppose the cooling air flow with as little flow resistance as possible.

The drive 30 and its respective sections/parts/components are cooled by one or more cooling units which can also be implemented as liquid cooling (cooling jacket on housing 2 of the dynamo-electric rotary machine 1 and/or on the bearing shield 7).

It is likewise possible to provide one or more internal fans in the converter installation space 13 and/or motor interior 18, which rotate within the converter installation space 13 and/or motor interior 18 and lead to air turbulence, which additionally cools the components of the converter 16 and/or stator 4 and rotor 6. The internal fans can either be controlled separately as external fans in a temperature-dependent manner. The internal fans can also be coupled mechanically or magnetically to the shaft 8, such that a type of self-ventilation of the converter installation space 13 and/or motor interior 18 occurs as soon as the shaft 8 rotates.

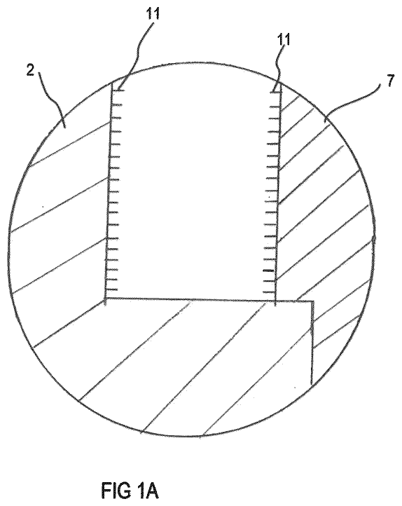

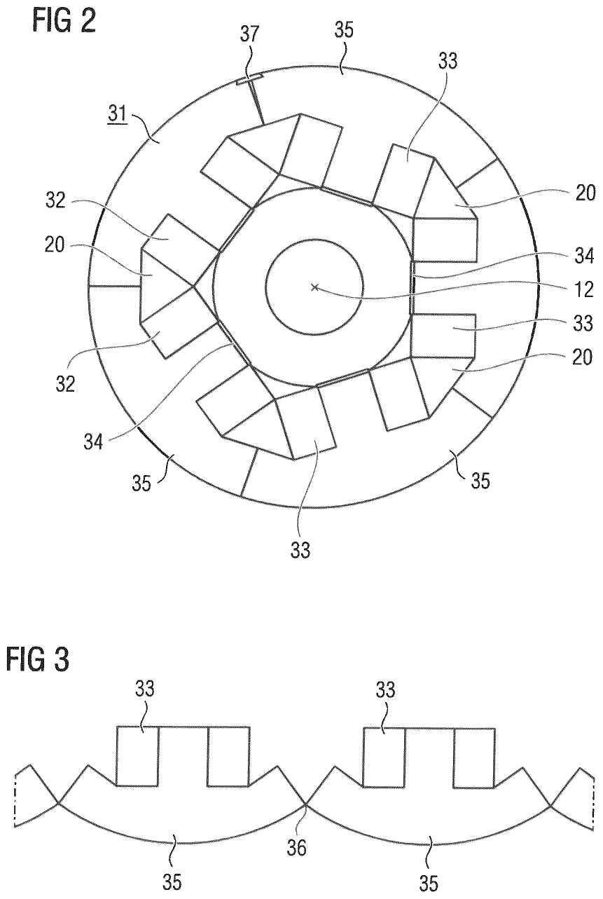

FIG. 2 shows a cross section of an already circumferentially assembled choke body 31 which is constructed from choke body elements 35. The choke body 31 includes an outer part with teeth and a separate inner part with a shaft passage 9. The required air gap is established between the two parts via spacer elements 34 or a connected spacer tube. The laminated core of the choke body 31 is stacked with individual laminations and held together by stapling or by baked lacquer or by package punching. The choke body 31 carries both the two DC link chokes 32 and the three line chokes 33.

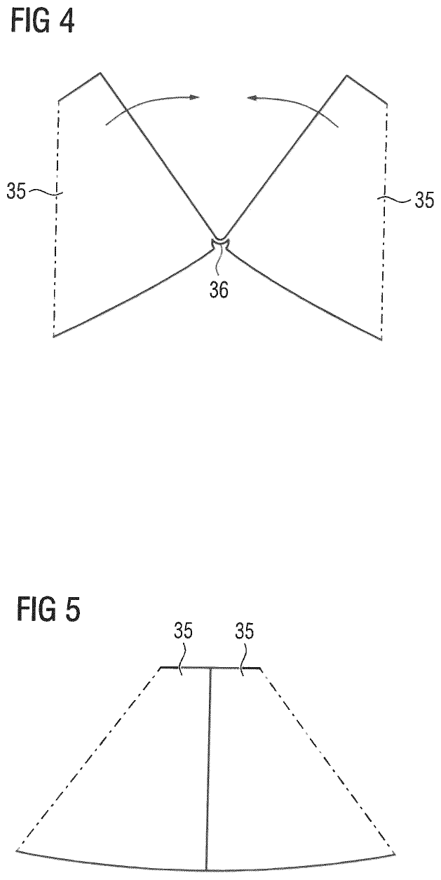

The individual coils of the chokes 32, 33 are either machined on a winding body and then plugged onto the teeth of the choke body elements 35 or wound directly onto the previously insulated choke body elements 35. For this purpose, the choke body 31 is of split design as shown in FIG. 3. By means of a specially formed sheet metal web 36 as a radially outer connection of the individual choke body elements 35, in particular of the respective laminations, the coils can then be folded in an almost gap-free manner according to FIGS. 4 and 5.

Optionally, the triangular region 20 can thus also be wound between two adjacent coils. The axial extent of the coil must be considered here to not adversely affect compactness of the drive 30.

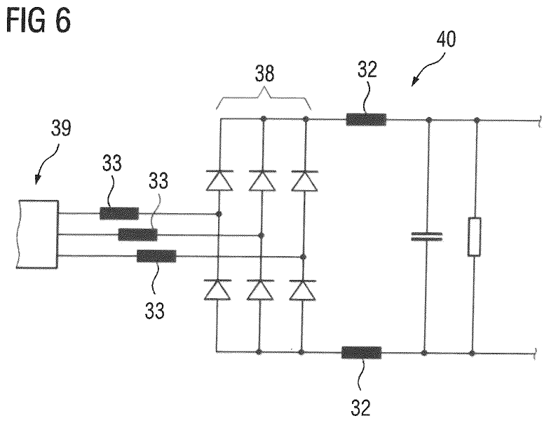

As can be shown by calculations for a voltage DC link converter with diode infeed, the greatest reduction in line-side harmonics results from a combination of DC link chokes 32 with line-side chokes 33 in accordance with FIG. 6.

The folded choke body 31 is inserted axially into the housing 2 and fixed there. For this purpose, spreader wedges 37 are introduced on one or both sides in accordance with FIG. 2.

Contacting of the individual chokes (to the terminal box 14, winding system 15, converter elements 15 and/or possibly series connections of individual coils, etc.) in the assembly sequence is based on the contacting concept of the drive 30.

The choke body 31 can hereby have different dimensions of DC link and line chokes 32, 33, and thus an unbalanced geometry, and can have the splitting of the respective coils into a plurality of individual coils in a series connection. This can be advantageous thermally or else geometrically (approximation of the coil cross section to a rectangle).

Geometry and arrangement of the choke body 31 are adapted to the motor housing 2. This leads to an optimum utilization of space, and thus the greatest possible choke inductance and therefore also the greatest possible effect in terms of minimizing the circuit feedback can be achieved.

Such compact drives 30 are used in compressors, fans, compactors and pumps in the industrial environment, but also in mobility applications such as trains or e-trucks, where a comparatively high compactness of powerful drives 30 is particularly important. Due to the compact drive 30, a specified clearance gauge is also maintained, which offers advantages when retrofitting.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A drive, comprising:
a housing;
a dynamo-electric rotary machine arranged in the housing, said dynamo-electric rotary machine comprising a stator, a winding system arranged in the stator, and a rotor which is separated from the stator by an air gap, with the stator and the rotor being located in a motor interior;
a B-side pot-shaped bearing shield comprising a bearing supporting the rotor for rotation about an axis;
a converter comprising at least one component selected from the group consisting of power semiconductor, capacitor, control and regulating unit, and communications unit, said converter being situated in a converter installation space which is radially surrounded at least in one section by the B-side bearing shield, wherein the at least one component of the converter is thermally conductively connected to the B-side bearing shield, said converter being arranged, as viewed axially, between the dynamo-electric rotary machine and the bearing of the B-side bearing shield; and
a choke body separating the motor interior and the converter installation space and comprising chokes.

2. The drive of claim 1, wherein the at least one component is a heat-intensive component of the converter.

3. The drive of claim 2, wherein the heat-intensive component of the converter is arranged on an inner side wall of the B-side bearing shield.

4. The drive of claim 1, wherein the choke body has an outer circumference which complements an inner circumference of the housing, said choke body including a substantially centrally configured shaft passage.

5. The drive of claim 1, wherein the choke body is annular in shape.

6. The drive of claim 1, wherein the choke body is constructed from circumferentially arranged choke body elements.

7. The drive of claim 6, wherein the choke body elements are linked on an outer circumference by sheet metal webs.

8. The drive of claim 1, wherein the choke body includes chokes/coils, in particular with a radially oriented coil axis.

9. The drive of claim 8, wherein the chokes are designed as a line choke or a DC link choke.

10. The drive of claim 1, wherein the choke body is connected at least in one section to the housing and/or the B-side bearing shield in an electrically and/or thermally conducting manner.

11. The drive of claim 10, further comprising an expansion bolt designed to fix the choke body in the housing.

12. The drive of claim 1, wherein the B-side bearing shield has an outer side wall with at least one section formed with cooling fins.

13. The drive of claim 1, wherein the housing has at least one section formed with axially running cooling fins.

14. The drive of claim 12, wherein the housing has at least one section formed with axially running cooling fins, wherein the cooling fins of the B-side bearing shield and the cooling fins of the housing are aligned axially.

15. The drive of claim 1, further comprising a cooling unit attached axially outside the B-side bearing shield and embodied as a fan unit designed as an integral fan and/or an external fan and generating a cooling air flow at least in one section over the B-side bearing shield and the dynamo-electric rotary machine.

16. The drive of claim 1, for use in a compressor, fan, compactor, pump in an industrial environment and in a mobility application.
